(19) United States
(12) Patent Application Publication
(10) Pub. No.: US 2011/0093946 A1
(43) Pub. Date: Apr. 21, 2011

(54) ROUTER AND METHOD FOR PROTECTING TCP PORTS UTILIZING THE SAME

(75) Inventor: Jong-Chang Chen, Tu-Cheng (TW)

(73) Assignee: Hon Hai Precision Industry Co., Ltd., Tu-Cheng (TW)

(21) Appl. No.: 12/641,543

(22) Filed: Dec. 18, 2009

(30) Foreign Application Priority Data
Oct. 20, 2009 (CN) 200910308498.7

(51) Int. Cl. G06F 21/20; G06F 15/16

(52) U.S. Cl. 726/13

(57) ABSTRACT

A router and method for protecting transfer control protocol (TCP) ports of a local computer include receiving a SYN packet from a remote computer, recording a timestamp of the SYN packet, and counting a number of suspicious TCP connections established during a first time interval before the timestamp of the SYN packet. The router and method further include identifying the remote computer as an attacker if the counted number exceeds a preset maximum connection value, and rejecting all TCP packets transmitted from the remote computer during the second time interval after the timestamp of the SYN packet.

### BACKGROUND

1. Technical Field

Embodiments of the present disclosure relate to computer security, and more particularly to a router and a method for protecting transfer control protocol (TCP) ports of a computer utilizing the router.

2. Description of Related Art

A local computer may connect with remote electronic devices, such as remote computers, mobile phones, through a modem, a router, and a network. If the remote electronic devices send TCP packets to the local computer to establish TCP connections, efficiency of the local computer suffers. If the TCP packets include fake packets, the fake packets may consume or occupy a disproportional amount of system resources (e.g., CPU, memory and network bandwidth) of the local computer.

What is needed, therefore, is an improved router and method for protecting TCP ports of a computer by utilizing the router.

### BRIEF DESCRIPTION OF THE DRAWINGS

FIG. 1 is a block diagram of one embodiment of a router connected with a local computer.

FIG. 2 is a block diagram of one embodiment of function modules of the router of FIG. 1.

FIG. 3 is a schematic diagram of one embodiment of a TCP connection between the local computer and a remote computer.

FIG. 4 is a flowchart of a first embodiment of a method for protecting TCP ports using the router of FIG. 1.

FIG. 5 is a flowchart of a second embodiment of a method for confirming idle TCP connections of FIG. 4.

FIG. 6 is a flowchart of the second embodiment of a method for protecting the TCP ports using the router of FIG. 1.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

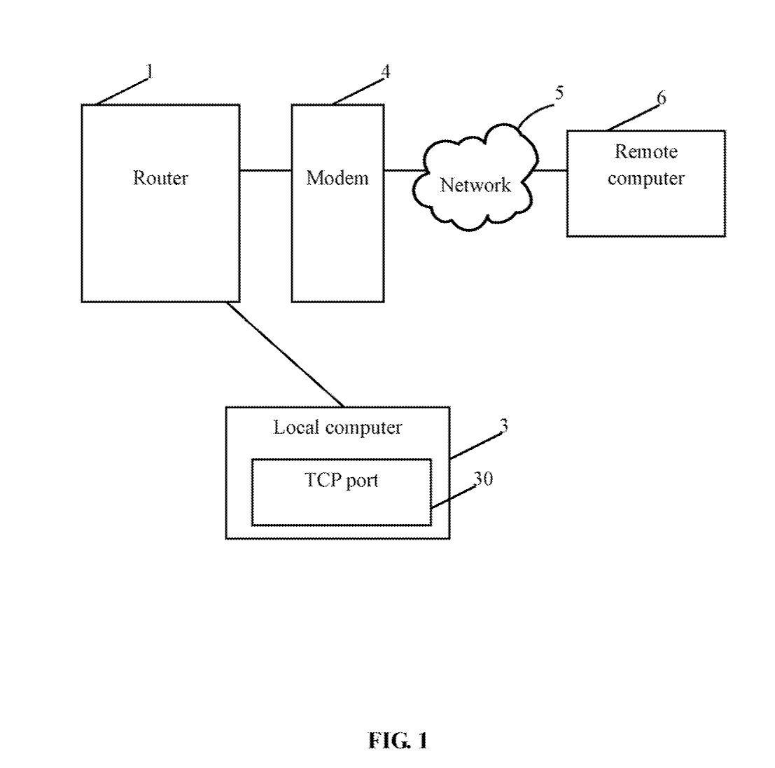

FIG. 1 is a block diagram of one embodiment of a router 1 connected with a local computer 3. The local computer 3 may connect to a plurality of remote computers (only one is shown in FIG. 1) 6 through the router 1, a modem 4, and a network 5. The router 1 may be used to protect TCP ports 30 of the local computer 3 from malicious attacks of the remote computer 6. In one embodiment, the remote computer 6 may scan the TCP ports 30 by sending many packets (e.g., packet flooding) to the local computer 3. In another embodiment, the remote computer 6 may send packets including viruses to the local computer 3.

The network 5 may be the Internet, or a communication network, for example.

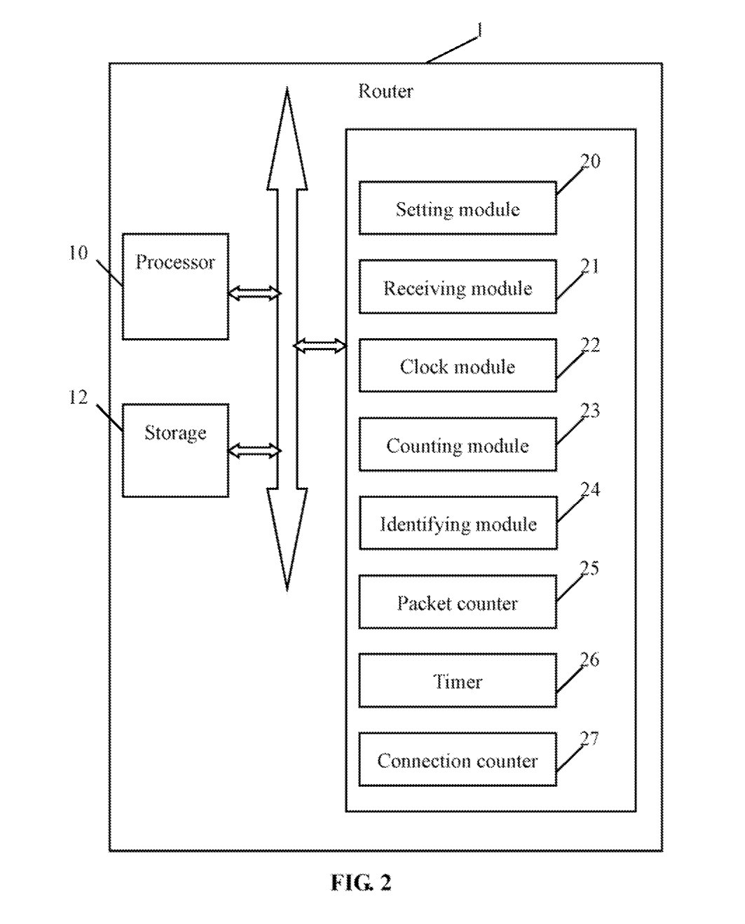

FIG. 2 is a block diagram of one embodiment of function modules the router 1. The router 1 may include a processor 10 and a storage 12. The processor 10 executes one or more computerized operations of the router 1 and other applications, to provide functions of the router 1. The storage 12 stores various kinds of data, such as preset configuration data, for example. In one embodiment, the storage 12 may be a memory of the router 1 or an external storage device, such as a memory stick, a smart media card, a compact flash card, or any other type of memory card.

In one embodiment, the router 1 may include a setting module 20, a receiving module 21, a clock module 22, a counting module 23, an identifying module 24, packet counter 25, a timer 26, and a connection counter 27. The modules 20-27 may comprise one or more computerized codes to be executed by the processor 10 to perform one or more operations of the router 1. Details of these operations will be provided below.

The setting module 20 presets a first time interval and a second time interval, and presets a maximum connection value to allow a remote computer 6 to connect with the local computer 3. Details of functions of the first time interval and the second time interval will be provided below.

The receiving module 21 receives various kinds of TCP packets. In one embodiment, the TCP packets may include, but are not limited to, SYN packets, SYN ACK packets, RST packets, RST ACK packets, FIN packet, FIN ACK packets, and other data packets, for example.

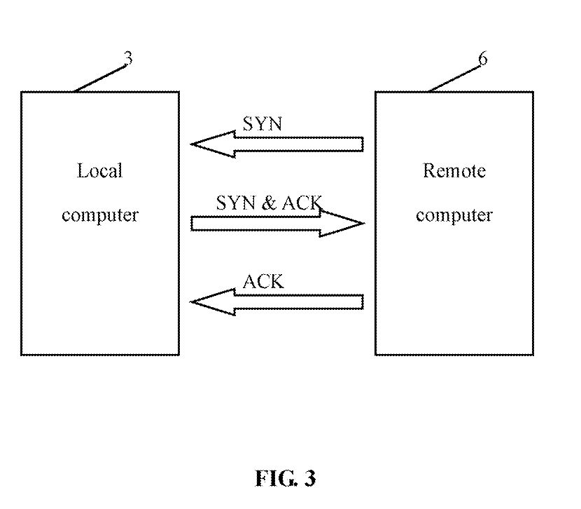

Before a TCP connection is established between the local computer 3 and the remote computer 6, the local computer 3 and the remote computer 6 need to accomplish a three-way handshake. As a TCP connection shown in FIG. 3, the remote computer 6 sends a SYN packet to the local computer 3 to establish a TCP connection with the local computer 3. In one embodiment, if the TCP port 30 of the local computer 1 is open, the local computer 3 returns a SYN ACK packet to the remote computer 6 through the router 1 and the network. After receiving the SYN ACK packet from the local computer 3, the remote computer 6 sends an ACK packet to the local computer 3, and the TCP connection is established. Other data packets may be transmitted between the remote computer 6 and the local computer 3 through the TCP connection.

In another embodiment, if the TCP port 30 of the local computer 1 is closed, the local computer 3 returns a RST packet to the remote computer 6. If the TCP connection needs to be disconnected, more packets need to be transmitted between the local computer 3 and the remote computer 6 to confirm the disconnection.

The clock module 22 records a timestamp of each packet received by the receiving module 21. In one embodiment, if the remote computer 6 sends the SYN packet to the local computer 3 to establish the TCP connection, the clock module 22 records a timestamp of the SYN packet.

The counting module 23 counts a number of suspicious TCP connections between the remote computer 6 and the local computer 3 established during the first time interval before the timestamp of the SYN packet. In one embodiment, the suspicious TCP connections do not transmit any other data packet after the TCP connections have been established by accomplishing the three-way handshake. For example, when the timestamp of the SYN packet is AM 9:05:12, the first time interval is 10 seconds, and the counting module 23 counts the number of suspicious TCP connections from AM 9:05:02 to AM 9:05:12.

The identifying module 24 identifies the remote computer 6 as an attacker if the counted number exceeds the maximum connection value, and rejects all TCP packets transmitted from the remote computer 6 during the second time interval after the timestamp of the SYN packet. In one embodiment, the maximum connection value is 20, and the second time interval is 10 minutes. If the counted number of the suspicious TCP connections exceeds 20, the identifying module 24 rejects all TCP packets transmitted by the remote computer 6 from AM 9:05:12 to AM 9:15:12.

In another embodiment, the setting module 20 may further preset a time threshold and a minimum packet number to determine if the TCP connection between the remote computer 6 and the local computer 3 is idle, and preset an idle connection limit. Details of the idle connection limit will be provided below.

The timer 26 is enabled to determine an idle time of the TCP connection once the TCP connection is established.

The packet counter 25 counts a packet number of TCP packets received by the local computer 3 from the remote computer 6. The number of the TCP packets (e.g., the SYN packet, the SYN ACK packet, and the ACK packet) transmitted during the three-way handshake is not counted.

The identifying module 24 determines that the TCP connection is idle if the idle time of the TCP connection reaches the time threshold and the packet number does not exceed the minimum packet number.

The connection counter 27 counts a total number of idle connections of the TCP connection(s) (e.g., how many idle connections there are of the TCP connections).

The identifying module 24 identifies the remote computer 6 as an attacker if the total number of idle connections exceeds the idle connection limit, and rejects/drops all TCP packets transmitted from the remote computer 6 during the second time interval after identifying the remote computer 6 as an attacker. For example, if the identifying module 24 identifies the remote computer 6 as an attacker at AM 9:00:00, and the second time interval is 10 minutes, thus, the identifying module 24 rejects all TCP packets sent by the remoter computer 6 from AM 9:00:00 to AM 9:10:00.

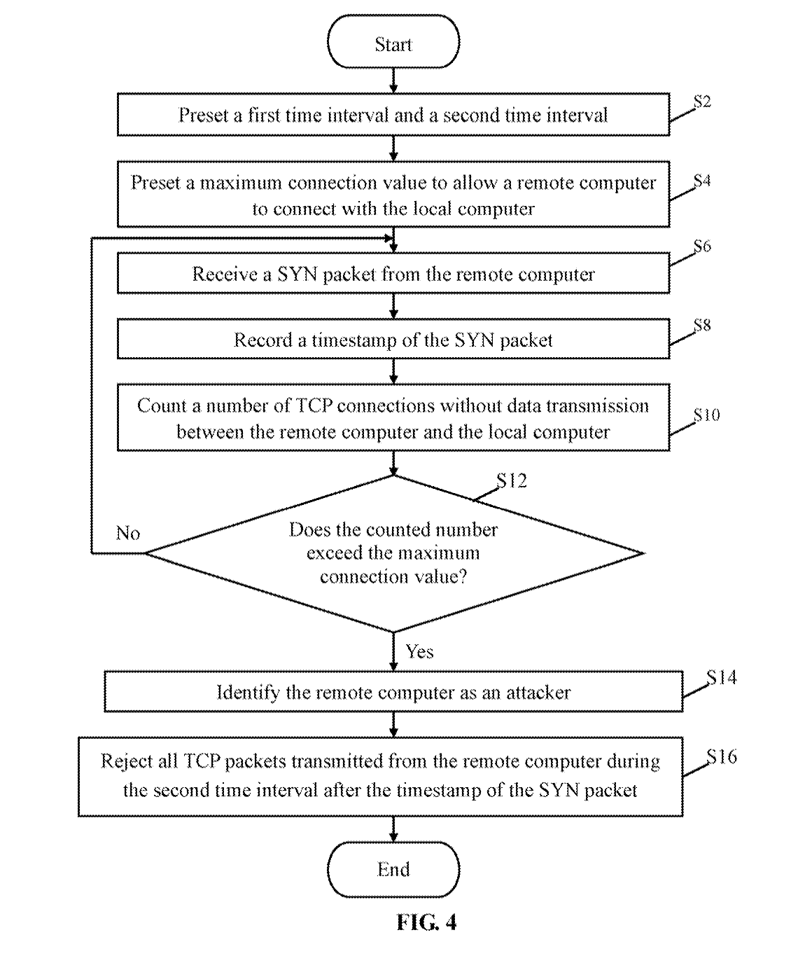

FIG. 4 is a flowchart of a first embodiment of a method for protecting the TCP ports 30 using the router 1 of FIG. 1. Depending on the embodiment, additional blocks may be added, others removed, and the ordering of the blocks may be replaced.

In block S2, the setting module 20 presets a first time interval and a second time interval. Details of functions of the first time interval and the second time interval will be provided below.

In block S4, the setting module 20 presets a maximum connection value to allow a remote computer 6 to connect with the local computer 3.

In block S6, the receiving module 21 receives a SYN packet from the remote computer 6. The remote computer 6 sends the SYN packet to the local computer 3 to establish a TCP connection.

In block S8, the clock module 22 records a timestamp of the SYN packet.

In block S10, the counting module 23 counts a number of suspicious TCP connections between the remote computer 6 and the local computer 3 established during the first time interval before the timestamp of the SYN packet. In one embodiment, the suspicious TCP connections do not transmit any other data packet after the TCP connections have been established by accomplishing the three-way handshake.

In block S12, the identifying module 24 identifies if the counted number exceeds the maximum connection value.

If the counted number exceeds the maximum connection value, in block S14, the identifying module 24 identifies the remote computer 6 as an attacker. If the counted number does not exceed the maximum connection value, the procedure returns to block S6.

In block S16, the identifying module 24 rejects all TCP packets transmitted from the remote computer 6 during the second time interval after the timestamp of the SYN packet.

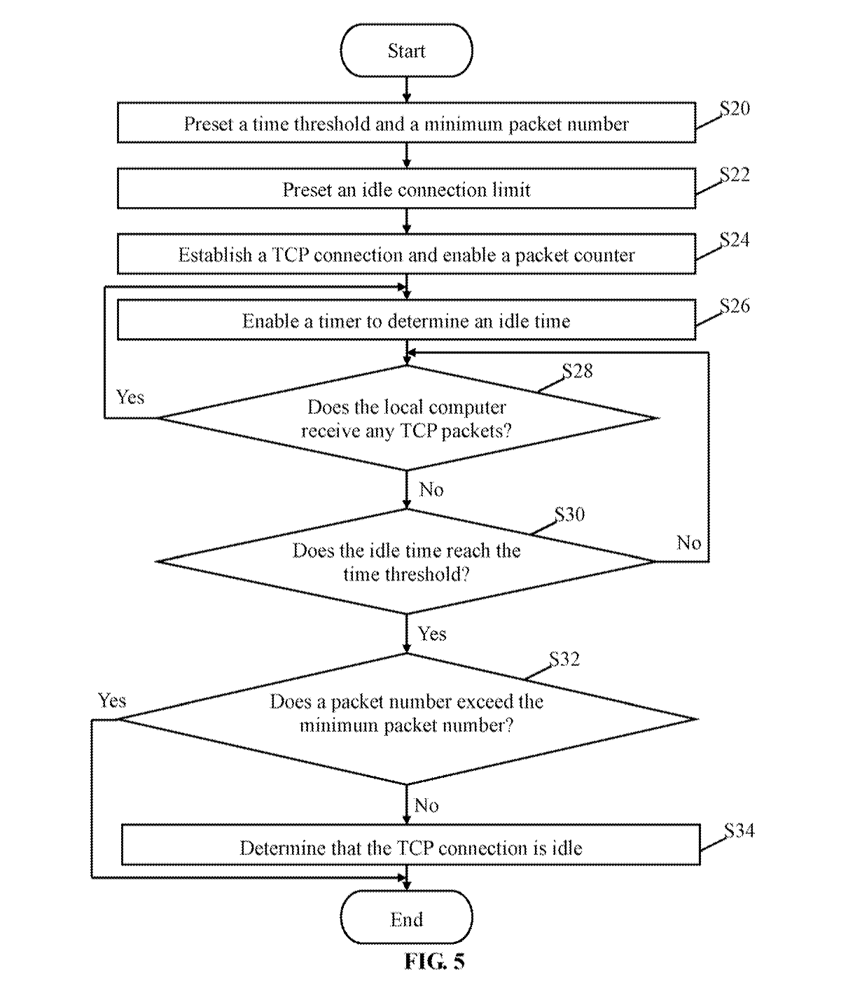

FIG. 5 is a flowchart of a second embodiment of a method for confirming idle TCP connections of FIG. 4. Depending on the embodiment, additional blocks may be added, others removed, and the ordering of the blocks may be replaced.

In block S20, the setting module 20 presets a time threshold and a minimum packet number to determine if the TCP connection between the remote computer 6 and the local computer 3 is idle.

In block S22, the setting module 20 presets an idle connection limit.

In block S24, the packet counter 25 counts a packet number of TCP packets received by the local computer 3 from the remote computer 6 after the TCP connection is established. The number of TCP packets (e.g., the SYN packet, the SYN ACK packet, and the ACK packet) transmitted during the three-way handshake is not counted.

In block S26, the timer 26 is enabled to determine an idle time of the TCP connection.

In block S28, the identifying module 24 determines if the local computer 3 receives any TCP packets from the remote computer 6. If the local computer 3 receives one or more TCP packets from the remote computer 6, the procedure returns to block S26 to reset the timer 26.

If the local computer 3 does not receive any TCP packets from the remote computer 6, in block S30, the identifying module 24 determines if the idle time of the TCP connection reaches the time threshold. If the idle time of the TCP connection does not reach the time threshold, the procedure returns to block S28.

If the idle time of the TCP connection reaches the time threshold, in block S32, the identifying module 24 determines if the packet number exceeds the minimum packet number. If the packet number exceeds the minimum packet number, the procedure ends.

If the packet number does not exceed the minimum packet number, in block S34, the identifying module 24 identifies that the TCP connection is idle.

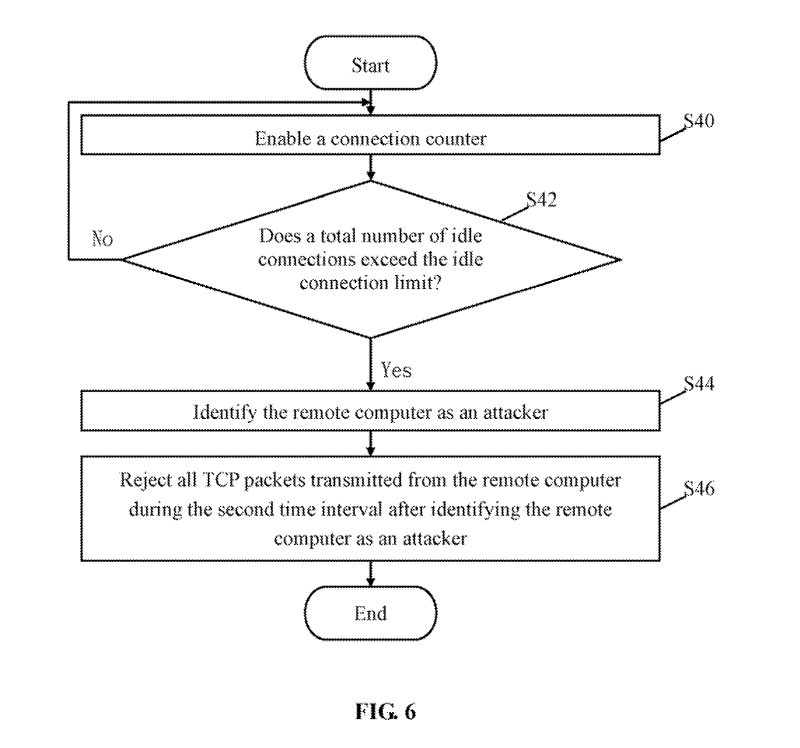

FIG. 6 is a flowchart of a second embodiment of a method for protecting the TCP ports 30 using the router 1 of FIG. 1. Depending on the embodiment, additional blocks may be added, others removed, and the ordering of the blocks may be replaced.

In block S40, the connection counter 27 is enabled to count a total number of idle connections of the TCP connection(s) between the remote computer 6 and the local computer 3.

In block S42, the identifying module 24 determines if the total number of idle connections exceeds the idle connection limit. If the total number of idle connections does not exceed the idle connection limit, the procedure returns to block S40.

If the total number of idle connections exceeds the idle connection limit, in block S44, the identifying module 24 identifies the remote computer 6 as an attacker.

In block S46, the identifying module 24 rejects all TCP packets transmitted from the remote computer 6 during the second time interval after identifying the remote computer 6 as an attacker.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for protecting transfer control protocol (TCP) ports of a local computer using a router, the local computer being connected with the router, the method comprising:
presetting a plurality of parameters to protect the TCP ports of the local computer using the router, the plurality of parameters comprising a first time interval, a second time interval, and a maximum connection value to allow a remote computer to connect with the local computer;
receiving a SYN packet by the local computer from the remote computer;
recording a timestamp of the SYN packet;
counting a number of TCP connections without data transmission between the remote computer and the local computer, the TCP connections without data transmission established during the first time interval before the timestamp of the SYN packet;
identifying the remote computer as an attacker if the counted number exceeds the maximum connection value; and
rejecting all TCP packets transmitted from the remote computer during the second time interval after the timestamp of the SYN packet.

2. The method according to claim 1, further comprising:
presetting a time threshold and a minimum packet number to determine if a TCP connection between the remote computer and the local computer is idle;
enabling a packet counter to count a packet number after the TCP connection is established;
enabling a timer to determine an idle time of the TCP connection;
determining if the local computer receives any TCP packets from the remote computer;
determining if the idle time reaches the time threshold if the local computer receives no TCP packets from the remote computer;
determining if the packet number exceeds the minimum packet number if the idle time reaches the time threshold; and
determining that the TCP connection is idle if the packet number counted by the packet counter does not exceed the minimum packet number.

3. The method according to claim 2, further comprising:
presetting an idle connection limit;
enabling a connection counter to count a total number of idle connections when the TCP connection is established; and
identifying the remote computer as an attacker if the total number of idle connections exceeds the idle connection limit; and
rejecting all TCP packets transmitted from the remote computer during the second time interval after identifying the remote computer as an attacker.

4. The method according to claim 2, further comprising:
resetting the timer if the local computer receives one or more TCP packets from the remote computer.

5. The method according to claim 1, wherein the local computer establishes the TCP connection with the remote computer by accomplishing three-way handshake.

6. The method according to claim 1, wherein the TCP packets comprise SYN packets, SYN ACK packets, RST packets, RST ACK packets, FIN packet, FIN ACK packets, and data packets transmitted during the TCP connection.

7. A router, the router comprising:
a storage;
at least one processor; and
one or more programs stored in the storage and being executable by the at least one processor, the one or more programs comprising:
a setting module operable to preset a plurality of parameters to protect transfer control protocol (TCP) ports of a local computer connected with the router, the plurality of parameters comprising a first time interval, a second time interval, and a maximum connection value to allow a remote computer to connect with the local computer;
a receiving module operable to receive a SYN packet by the local computer from the remote computer;
a clock module operable to record a timestamp of the SYN packet;
a counting module operable to count a number of TCP connections without data transmission between the remote computer and the local computer, the TCP connections without data transmission established during the first time interval before the timestamp of the SYN packet; and
an identifying module operable to identify the remote computer as an attacker if the counted number exceeds the maximum connection value, and reject all TCP packets transmitted from the remote computer during the second time interval after the timestamp of the SYN packet.

8. The router according to claim 7, wherein the one or more programs further comprises a timer and a packet counter:
the setting module is further operable to preset a time threshold and a minimum packet number to determine if a TCP connection between the remote computer and the local computer is idle;
the timer is operable to determine an idle time of a TCP connection after the TCP connection is established;
the packet counter is operable to count a packet number of TCP packets received by the local computer from the remote computer; and
the identifying module is further operable to determine that the TCP connection is idle if the idle time reaches the time threshold and the packet number does not exceed the minimum packet number.

9. The router according to claim 8, wherein the one or more programs further comprise a connection counter:
the setting module is further operable to preset an idle connection limit
the connection counter is operable to count a total number of idle connections when the TCP connection is established; and
the identifying module is further operable to identify the remote computer as an attacker if the total number of idle connections exceeds the idle connection limit, and reject all TCP packets transmitted from the remote computer during the second time interval after identifying the remote computer as an attacker.

10. The router according to claim 8, wherein the timer is reset if the local computer receives one or more TCP packets from the remote computer.

11. The router according to claim 7, wherein the local computer establishes the TCP connection with the remote computer by accomplishing three-way handshake.

12. The router according to claim 7, wherein the TCP packets comprise SYN packets, SYN ACK packets, RST packets, RST ACK packets, FIN packet, FIN ACK packets, and data packets transmitted during the TCP connection.

13. A storage medium storing a set of instructions, the set of instructions capable of being executed by a processor to perform a method for protecting transfer control protocol (TCP) ports of a local computer using a router, the local computer being connected with the router, the method comprising:
presetting a plurality of parameters to protect the TCP ports of the local computer using the router, the plurality of parameters comprising a first time interval, a second time interval, and a maximum connection value to allow a remote computer to connect with the local computer;
receiving a SYN packet by the local computer from the remote computer;
recording a timestamp of the SYN packet;
counting a number of TCP connections without data transmission between the remote computer and the local computer, the TCP connections without data transmission established during the first time interval before the timestamp of the SYN packet;
identifying the remote computer as an attacker if the counted number exceeds the maximum connection value; and
rejecting all TCP packets transmitted from the remote computer during the second time interval after the timestamp of the SYN packet.

14. The storage medium as claimed in claim 13, wherein the method further comprises:
presetting a time threshold and a minimum packet number to determine if a TCP connection between the remote computer and the local computer is idle;
enabling a packet counter to count a packet number after the TCP connection is established;
enabling a timer to determine an idle time of the TCP connection;
determining if the local computer receives any TCP packets from the remote computer;
determining if the idle time reaches the time threshold if the local computer receives no TCP packets from the remote computer;
determining if the packet number exceeds the minimum packet number if the idle time reaches the time threshold; and
determining that the TCP connection is idle if the packet number counted by the packet counter does not exceed the minimum packet number.

15. The storage medium as claimed in claim 14, wherein the method further comprises:
presetting an idle connection limit;
enabling a connection counter to count a total number of idle connections when the TCP connection is established; and
identifying the remote computer as an attacker if the total number of idle connections exceeds the idle connection limit; and
rejecting all TCP packets transmitted from the remote computer during the second time interval after identifying the remote computer as an attacker.

16. The storage medium as claimed in claim 14, wherein the method further comprises:
resetting the timer if the local computer receives one or more TCP packets from the remote computer.

17. The storage medium as claimed in claim 13, wherein the local computer establishes the TCP connection with the remote computer by accomplishing three-way handshake.

18. The storage medium as claimed in claim 13, wherein the TCP packets comprise SYN packets, SYN ACK packets, RST packets, RST ACK packets, FIN packet, FIN ACK packets, and data packets transmitted during the TCP connection.
